(19) United States
(12) Patent Application Publication
(10) Pub. No.: US 2019/0372444 A1
(43) Pub. Date: Dec. 5, 2019

(54) DUAL CONTROL SYSTEM OF THE ROTOR OF A PERMANENT MAGNET GENERATOR

(71) Applicant: De la Asunsion Interactiva S.A., Central (PY)

(72) Inventors: Jose Carlos RAMIREZ, Central (PY); Emilce Raquel SOSA CANTERO, Central (PY)

(21) Appl. No.: 16/030,595

(22) Filed: Jul. 9, 2018

(30) Foreign Application Priority Data
May 31, 2018 (PY) P 1841296

(51) Int. Cl. H02K 21/48; H02K 16/02

(52) U.S. Cl. CPC H02K 21/48; H02K 2213/09; H02K 16/02

(57) ABSTRACT

Control system of a rotor of a permanent magnet generator which comprises a first fixed ring of permanent magnets and a second fixed ring of permanent magnets fixed at opposite ends of a rotor shaft, a first movable ring of permanent magnets movable on a guide axis situated on the side where the first fixed ring of permanent magnets is located and a second movable ring of permanent magnets movable on the guide axis situated on the side where the second fixed ring of permanent magnets is located such that the guide axis is joined to a stator of the generator and where the rotation of the rotor shaft is produced approximating and/or distancing the two movable rings of permanent magnets to and/or from the fixed rings of permanent magnets.

### CROSS REFERENCE TO RELATED APPLICATION

This application claims priority of Paraguay Application No. P 1841296 PY filed May 31, 2018, application which is incorporated herein by reference.

### FIELD OF THE INVENTION

The invention relates to a dual control system of the rotor of a permanent magnet generator which, by means of pairs of rings of permanent magnets, one pair located at each end, the rotational speed of the rotor is controlled and, therefore, the output power of a generator with permanent magnets. The system object of the invention belongs to the technical field of control and configuration mechanisms of the rotor of permanent magnet generators. The system object of the invention is applicable to the energy industry, specifically the industry for power generation.

### BACKGROUND OF THE INVENTION

In a permanent magnet generator, the output voltage is proportional to the product of the speed of the rotor and the flow of the stator produced by the magnets of the rotor.

To control the output voltage, it is necessary to control the rotational speed of the rotor. At present, permanent magnet generators incorporate mechanisms such as the control of the rotor by means of a control switch connected to the coil, by pulse width modulation (PWM), by systems coupled to the rotor which are mounted on another structure separated from the stator, by coupling other systems also separated from the rotor or gearing system.

Some ideas of mechanisms related to these are described in U.S. Pat. No. 8,823,331 wherein a permanent magnet generator has a rail proportionally adjustable to the speed for self-regulation of coil output voltage. The speed proportional air gap is accomplished through the use of a plurality of centrifugal flyweights in mechanical coupling to a spool piece under spring load and to corresponding rare earth magnets via linkage such that increasing rotor speed extends the flyweights outward from the rotor center of rotation.

The document U.S. Pat. No. 5,874,797 discloses a permanent magnet generator which provides alternating current at a selected frequency which has at least one rotating ring of field magnets which produce a circular array of magnetic fields, and a ring of generator output coils which are in the magnetic fields. The field magnets are permanent magnets. The generator output coils are movable in a displacement path toward and away from a null position at which they are exposed to zero net flux from the magnetic fields. The coils provide a raw amplitude-modulated signal that has a carrier frequency which is a function of the rotational velocity of the field magnets and a modulation frequency that is proportional to the mechanical oscillation of the generator output coils.

The document U.S. Pat. No. 3,676,764 relates to a self-excited brushless alternating current generator which utilizes a four-pole direct current excitation winding wound on a stator and operable to generate an exciter flux which induces an alternating current in a field excitation winding wound on a rotor. The field excitation winding connects through rectifiers to a d-c main field winding also wound on the rotor.

The document U.S. Pat. No. 7,893,588 B1 discloses a magnetic electron exciter includes a rotor adapted to be rotated within a preselected range of rotational speeds, and having a plurality of magnets mounted therein preselected distances from the rotational axis of the rotor. A plurality of coils are positioned adjacent to the rotor, whereby rotation of the rotor creates an electrical current in the coils. First and second electrodes are spaced apart a predetermined distance, and are electrically connected with the coils to create an arc between the electrodes when the rotor is rotated relative to the coils.

However, the invention object of the invention differs from these with a control system of a rotor of a permanent magnet generator through a system of external and internal rings formed by permanent magnets.

### DESCRIPTION OF THE INVENTION

The object of the invention is a control system of a rotor of a permanent magnet generator which comprises a first fixed ring of permanent magnets fixed at one end of a rotor shaft, a second fixed ring of permanent magnets fixed at an opposite end of the rotor shaft, a first movable ring of permanent magnets movable on a guide axis situated at the side where the first fixed ring of permanent magnets is located and a second movable ring of permanent magnets movable on the guide axis situated at the side where the second fixed ring of permanent magnets is located.

In the control system of a rotor of a permanent magnet generator object of the invention, the guide axis is joined to a stator of the generator and the rotation of the rotor shaft is produced approximating and/or distancing the two movable rings of permanent magnets to the fixed rings of permanent magnets by means of a regulation selector.

In the control system of a rotor of a permanent magnet generator object of the invention, the first fixed ring of permanent magnets, the second fixed ring of permanent magnets, the first movable ring of permanent magnets and the second movable ring of permanent magnets comprise a plurality of housings where the permanent magnets are located.

The magnets of the control system of a rotor of a permanent magnet generator object of the invention are curved magnets.

In the control system of a rotor of a permanent magnet generator object of the invention, the magnets are facing one another inclined at an angle of between 23.5° and 25.5°, using the same polarity between the housings of each ring.

### BRIEF DESCRIPTION OF THE FIGURES

FIG. 1 shows a lateral view of the dual control system of the rotor of a permanent magnet generator object of the invention.

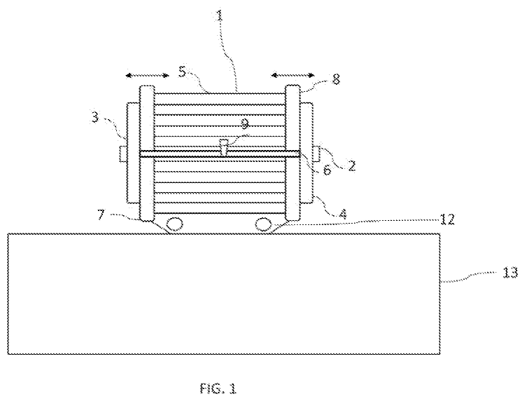

FIG. 2 shows a lateral elevation view of the dual control system of the rotor object of the invention.

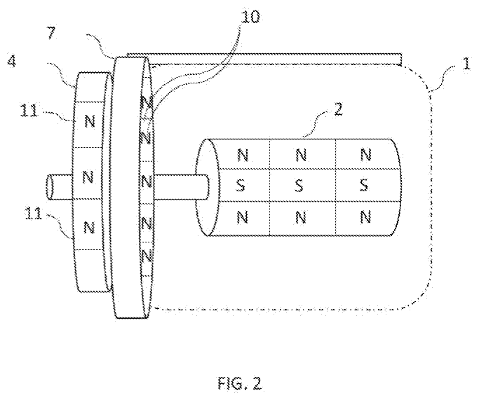

The different reference numerals which are found in the figures correspond to the following elements:

1. generator,

2. rotor shaft,

3. first fixed ring of permanent magnets,

4. second fixed ring of permanent magnets,

5. stator,

6. guide axis,

7. first movable ring of permanent magnets,

8. second movable ring of permanent magnets,

9. regulation selector,

10. housings,

11. magnets,

12. support and

13. structure.

### DETAILED DESCRIPTION OF THE INVENTION

The dual control system of a rotor of a permanent magnet generator (1) comprises a first fixed ring of permanent magnets (3) and a second fixed ring of permanent magnets (4) which are fixed to a rotor shaft (2) such that the first fixed ring of permanent magnets (3) is fixed at one end of the rotor shaft (2) and the second fixed ring of permanent magnets (4) is fixed at the opposite end of the rotor shaft (2).

The dual control system of a rotor of a permanent magnet generator (1) also comprises a first movable ring of permanent magnets (7) and a second movable ring of permanent magnets (8) such that the movable rings of permanent magnets (7, 8) are joined to a guide axis (6) on which they are moved, the cited guide axis (6) in turn is joined to the stator (5) of the generator (1).

All the rings of magnets (3, 4, 7, 8) comprise housings (10) in which the magnets (11) are situated.

The first movable ring of permanent magnets (7) is situated on the same side of the generator (1) on which the first fixed ring of permanent magnets (3) is located and the second movable ring of permanent magnets (8) is situated on the same side of the generator on which the second fixed ring of permanent magnets (4) is located.

The rotation of the rotor shaft (2) is produced by the repulsion of the magnetic field between magnets with equal sign and therefore it is produced approximating and/or distancing the two movable rings of permanent magnets (7, 8) to the fixed rings of permanent magnets (3, 4).

The system object of the invention comprises a regulation selector (9) which in the preferred embodiment of the invention is a manual cam which approximates or distances the movable rings of permanent magnets (7, 8) according to the required angle such that the relative position of the movable rings of permanent magnets (7, 8) can be modified with respect to the fixed rings of permanent magnets (3, 4), that is to say, the movable rings of permanent magnets (7, 8) can be approximated to or distanced from the fixed rings of permanent magnets (3, 4).

Both the first fixed ring of permanent magnets (3), the second fixed ring of permanent magnets (4), the first movable ring of permanent magnets (7) and the second movable ring of permanent magnets (8) comprise a series of housings (10) where the magnets (11) are situated.

To improve the efficiency in the control of the rotation of the rotor, the magnets (11) are curved and are placed facing and inclined at an angle of between 23.5° and 25.5°, using the same polarity within the housings (10) of each ring (3, 4, 7, 8) such that they do not perpendicularly contact each other to maintain the opposition of the same magnetic field.

The generator (1) is joined to a support (12) such that the support (12) enables the joining with a structure (13) where the generator (1) can be situated.

1. A control system of a rotor of a permanent magnet generator, comprising:
a first fixed ring of permanent magnets fixed at one end of a rotor shaft, a second fixed ring of permanent magnets fixed at an opposite end of the rotor shaft,
a first movable ring of permanent magnets movable on a guide axis situated at the side where the first fixed ring of permanent magnets is located and
a second movable ring of permanent magnets movable on the guide axis situated at the side where the second fixed ring of permanent magnets is located
such that the guide axis is joined to a stator of the generator and wherein the rotation of the rotor shaft is produced approximating and/or distancing the two movable rings of permanent magnets to and/or from the fixed rings of permanent magnets by means of a regulation selector.

2. The control system of a rotor of a permanent magnet generator according to claim 1, wherein the first fixed ring of permanent magnets, the second fixed ring of permanent magnets, the first movable ring of permanent magnets and the second movable ring of permanent magnets comprise a plurality of housings wherein the permanent magnets are located.

3. The control system of a rotor of a permanent magnet generator according to claim 1, wherein the magnets are curved magnets.

4. The control system of a rotor of a permanent magnet generator according to claim 3, wherein the magnets are facing one another inclined at an angle of between 23.5° and 25.5°, using the same polarity between the housings of each ring.
